(19) United States
(12) Patent Application Publication
(10) Pub. No.: US 2012/0055128 A1
(43) Pub. Date: Mar. 8, 2012

(54) EXTENSION LAWNMOWER SYSTEMS

(76) Inventor: Vincent J. Sturdy, JR., Saddle Brook, NJ (US)

(21) Appl. No.: 13/045,545

(22) Filed: Mar. 11, 2011

Related U.S. Application Data
(60) Provisional application No. 61/380,544, filed on Sep. 7, 2010.

(51) Int. Cl. A01D 75/30

(52) U.S. Cl. 56/6

(57) ABSTRACT

A lawn mower system comprising a wheeled push lawn mower primary cutting deck having auxiliary pivotably attached secondary cutting decks attached thereto. The device powered by a motor that may be electric or an internal combustion engine which provides power to operate blade(s) in a horizontal rotary cutting motion. The cutting blades may be attached to the motor via connector shaft(s) and pulley(s) and may be simultaneously driven with a belt system to cut various widths of lawn. The auxiliary pivotably attached right and left secondary cutting decks are vertically rotatable into downward positions for single, double, or triple wide cutting widths to cut small to very large lawns. The lawn mower system may be stored in a wings-up efficient manner.

### CROSS-REFERENCE TO RELATED APPLICATION

The present application is related to and claims priority from prior provisional application Ser. No. 61/380,544, filed Sep. 7, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of lawn mowers and more specifically relates to extension lawn mowers.

2. Description of the Related Art

Many individuals own or rent homes that require a lawn to be maintained. Lawn mowers are machines that typically use revolving blade(s) to cut a lawn at a uniform length. Lawn mowers may use a blade that rotates on a horizontal plane. These mowers are known as rotary mowers, while those employing a blade assembly that rotates about a horizontal axis are typically known as cylinder or reel mowers. Many different designs of lawn mowers have been designed and manufactured, each suited to a specific purpose. The smallest types, pushed by a human, are suitable for small residential lawns and gardens, while larger, self-contained, ride-on mowers are more suited to large lawns, and the largest, multi-gang mowers pulled behind a tractor, are designed for large expanses of grass such as golf courses, highway road allowances and municipal parks.

Although the present lawn mowers are useful for their intended purpose there is room for improvements with respect to providing lawn mowers suitably efficient to mow larger plots of lawn at efficient rates, yet be storable within confined quarters. Property owners or renters that have dwellings on larger lots and cannot afford riding mowers will usually be tempted to delay the task of mowing the grass until it becomes necessary due to the considerable time required with a standard mower. Storage of a mower greater in size than a standard mower can be problematic as well. Storage space for most people in modern society is limited and time is a valuable commodity.

Various attempts have been made to solve the above-mentioned problems such as those found in U.S. Pat. Nos. 5,715,667 to Gerald Eugene Goman et al; 3,974,629 to Lionel E. Russell et al; and U.S. Pat. No. 7,062,898 to Cory E. Sarver et al. This prior art is representative of lawn mowers. None of the above inventions and patents, taken either singly or in combination, is seen to describe the invention as claimed.

Ideally, an extension lawn mower should be user-friendly, easy to maneuver, occupy only a small storage space, be inexpensive and efficient in operation, and, yet would operate reliably and be manufactured at a modest expense. Thus, a need exists for a reliable extension lawn mower system to mow large lawns and vegetation covered expanses and to avoid the above-mentioned problems.

### BRIEF SUMMARY OF THE INVENTION

In view of the foregoing disadvantages inherent in the known lawn mower art, the present invention provides a novel extension lawn mower system. The general purpose of the present invention, which will be described subsequently in greater detail, is to provide an efficient lawn mowing and storage means.

A lawn mower system is disclosed herein preferably comprising a wheeled push lawn mower primary cutting deck having at least one auxiliary pivotably attached first and secondary cutting decks connected thereto. The device comprises and is powered via a motor that may be electric or alternately powered by an internal combustion engine which serves to provide power to operate the blade(s) in a rotary motion.

The cutting means (cutting blades) may be in mechanical communication with the motor via connector shaft(s) and pulley(s) and may be connectably driven with a belt system or other suitable means. The primary cutting deck is designed to suitably shroud the cutting blade housed therein to protect the user from injury. The auxiliary pivotably attached secondary cutting deck(s) shroud the auxiliary cutting blade(s) while in use in a like manner to the primary cutting deck. The wheeled push lawn mower primary cutting deck and auxiliary pivotably attached secondary cutting deck(s) are usable for cutting at least one outdoor lawn.

The auxiliary pivotably attached secondary cutting decks discussed in the instant invention preferably comprise a left secondary cutting deck and a right secondary cutting deck hingedly mounted. The auxiliary pivotably attached secondary cutting decks are vertically rotatable about centerline axes (hinging means) on (outside) side edges located on the wheeled push lawn mower primary cutting deck. The rotation angle ranges from a horizontal-down position (in-use) to a vertical up (non-use-stored position.) The design of the auxiliary cutting decks function like ‘wings’. In certain embodiments left and right secondary cutting decks may have height-adjustable gauge wheels for cutting grass height at various lengths. In this way the present invention may be suitably stabilized to avoid ‘flex-fatigue’ stresses and to maintain an even-cut across the cutting surface.

Motor speed can be variably manipulated by a controller which can be handle-mounted or affixed to the motor in alternate embodiments. Optionally, a cuttings bag for containing lawn cuttings can be removably attached to the proximate end of the mower and to the handle for reducing lawn surface cleanup labor.

The present invention offers a variety of cutting width options. The wheeled push lawn mower primary cutting deck, when in combination with left and a right secondary cutting decks in a rotated down position preferably provides a ‘triple cutting width’ during an in-use condition. Options for using the present invention may further include: wheeled push lawn mower primary cutting deck when in combination with left secondary cutting deck rotated into a down operating position provides a double cutting width during an in use condition, wherein the dimensioning is suitable for such a width (right cutter not in operation); or wheeled push lawn mower primary cutting deck, when in combination with right secondary cutting deck rotated into a down operating position also providing a double cutting width during an in use condition (left cutter not in operation); or wheeled push lawn mower primary cutting deck, when in combination with right and left secondary cutting deck rotated into an upright non-operating position provides a single cutting width during an in use condition. In this way the device may be useful on a variety of different width areas/surfaces. The wheeled push lawn mower primary cutting deck when in combination with right and left secondary cutting deck(s) rotated into an upright non-operating position preferably provides a non-use condition/storage configuration. The storage configuration comprises a width of less than thirty six inches suitable to fit through a standard entry door and/or gate. Pins may also be used to secure auxiliary decks in their desired positioning as an added safety feature.

A method of use for a lawn mower system is also disclosed herein preferably comprising the steps of: removing the lawn mower assembly from storage for use; rotating right and/or left secondary cutting deck(s) downwardly into a horizontal planar relationship with the wheeled push lawn mower primary cutting deck; and engaging the motor to power at least one cutting blade to perform a lawn cutting operation. The method may further comprise the step of returning lawn mower assembly to the in-storage position during a non-use period. Further, as discussed above this novel mower may be used in different configurations and the method may be employed, as such with different cutting widths.

The present invention holds significant improvements and serves as an extension lawn mower system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Extension Lawn Mower System, constructed and operative according to the teachings of the present invention.

FIG. 1 shows a perspective view illustrating an extension lawn mower in an in-use position according to an embodiment of the present invention.

FIG. 2 is another perspective view illustrating the extension lawn mower in another in-use position according to an embodiment of the present invention of FIG. 1.

FIG. 3 is a perspective view illustrating the extension lawn mower in a non-use storage position according to an embodiment of the present invention of FIG. 1.

FIG. 4 is a perspective view illustrating a right secondary cutting deck and a left secondary cutting deck as coupled to a wheeled push lawn mower primary cutting deck of the extension lawn mower assembly according to an embodiment of the present invention of FIGS. 1 and 3.

FIG. 5 is a flowchart illustrating a method of use for the extension lawn mower assembly according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a lawn mower system and more particularly to an extension lawn mower system as used to reduce lawn maintenance time by providing efficient lawn mowing and storage means.

The Extension Lawn mower of the present invention comprises a specially designed, “environmentally-friendly”, push-operated lawn mower with incorporated, foldable extensions (wings) located on each side of the mower deck. The design intent is to provide a space-saving mower which can fit through small or standard-sized entrances that is also able to efficiently and effectively cover an increased cutting area when needed.

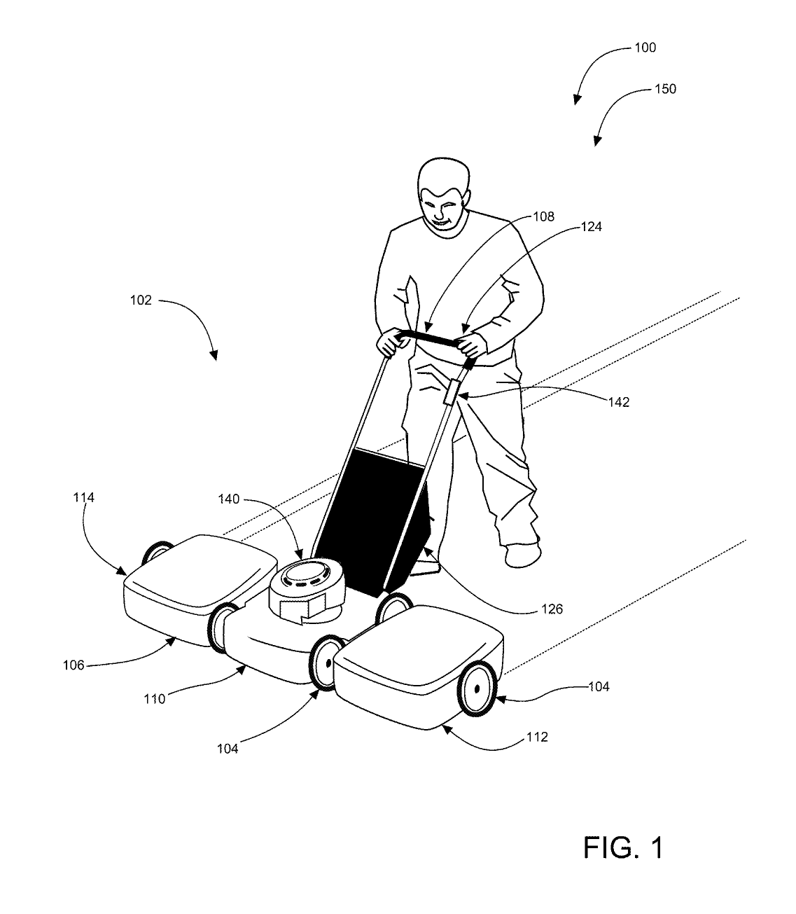

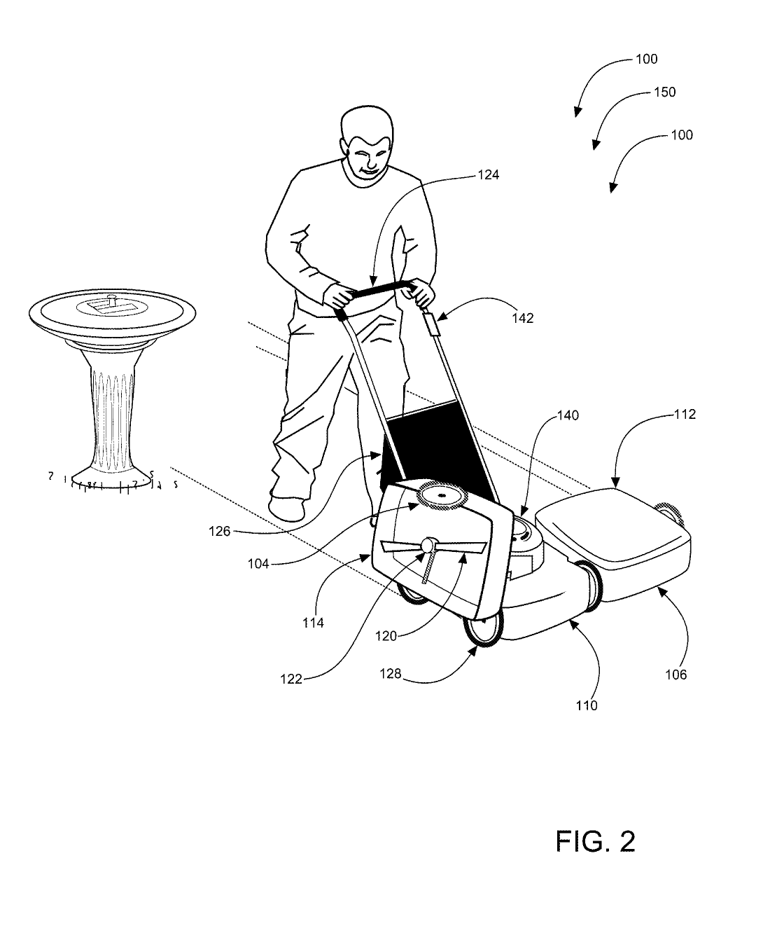

Referring to the drawings now by numerals of reference there is shown in FIGS. 1 and 2, perspective views illustrating extension lawn mower 102 in an in-use position 150 according to an embodiment of the present invention. Extension lawnmower system 100 preferably comprises wheeled push lawn mower primary cutting deck 110 having at least one cutting blade 120, connector shaft 122, motor 140, and controller 142. Primary cutting deck 110 shrouds cutting blade 120. In the embodiment shown extension lawnmower system 100 further preferably comprises at least one auxiliary pivotably attached secondary cutting deck 130. Primary cutting deck 110, while serving as a shroud may also provide mounting points for auxiliary pivotably attached secondary cutting deck(s) 130, thus may have extra reinforcement such that it is rendered sufficiently rigid and durable to compensate for the extra weight and flexion caused by such relationship. In this way the present invention is made to safely withstand various external forces to provide longevity, thereby providing cost-effective service in use.

The cutting blade(s) 120 may be directly or indirectly connected to motor 140 via connector shaft 122 wherein motor 140 provides power to operate cutting blade(s) 120 (preferably in a rotary motion) located within confines of auxiliary pivotably attached secondary cutting deck(s) 130 and primary cutting deck 110 using suitable power-transfer means (belts, pulleys, shafts, chains, sprockets or suitable equivalents.) In auxiliary pivotably attached secondary cutting deck(s) 130 cutting blade(s) 120 may comprise second cutting blade(s) in that the second (and third . . . etc.) blades may be identical to cutting blade(s) 120 or may be different size(s) and are just shroud-positioned within auxiliary pivotably attached secondary cutting deck(s) 130 as versus within confines of primary cutting deck 110. The speed of motor 140 may be variably manipulated by the lawn mower system controller 142 which may be handle-mounted to handle 124 (as in certain embodiments shown) for the convenience of the user. Motor 140 comprises an AC version of motor 140 in certain embodiments and in other embodiments may comprise an internal combustion engine which is used to power extension lawn mower 102.

As previously mentioned, at least one auxiliary pivotably attached secondary cutting deck 130 is preferably hingedly mounted to wheeled push lawn mower primary cutting deck 110; wherein the combination of wheeled push lawn mower primary cutting deck 110 and auxiliary pivotably attached secondary cutting deck(s) 130 are usable for cutting at least one outdoor lawn or vegetative surface. In certain embodiments left secondary cutting deck 112 and right secondary cutting deck 114 may utilize height-adjustable gauge wheels 104 for cutting various lengths of grass. Additionally, these optional height-adjustable gauge wheels 104 may provide upward support for left secondary cutting deck 112 and right secondary cutting deck 114 to minimize flexion. Other embodiments may not employ the use of wheels 104.

Extension lawnmower system 100, as shown, preferably comprises cuttings bag 126 for collecting grass clippings to eliminate much of the cleanup upon completion of the mowing operation. Cuttings bag 126 may be in communication with each of auxiliary pivotably attached secondary cutting decks 130 and primary cutting deck 110 if desired. It should be appreciated that primary cutting deck 110 and auxiliary pivotably attached secondary cutting decks 130 comprise a master/servant relationship when in series combination.

Extension lawnmower system 100 of the present invention is designed to provide home owners and professionals with a compactible mowing system that (up to) triples the cutting area, using one easy to manage unit/assembly. The present invention offers fully functional accessories with cutting blades 120 and wheel(s) 128, making extension lawnmower system 100 easily user-manipulatable to glide around shrubs and trees, curvy flower beds and other tight fitting areas, with ease, yet mows large areas of grass with extreme efficiency. While significantly decreasing the amount of time spent mowing, extension lawnmower system 100 offers additional, invaluable novel advantages. Primarily, the extensions (at least hereby enabling auxiliary pivotably attached secondary cutting decks 130) can be simply folded upwardly instead of being removed from the mower when finished, facilitating easy, space-saving storage in garages and trailers or other such confined enclosures.

In accordance with the design stated above, the unit's compactible sides enable the mower of the present embodiment to be easily maneuvered through a standard 36″ walk-in gate. This novel feature is especially useful and convenient for lawn service professionals, ground crews, offering these professionals a customizable/adaptable mower assembly when caring for their customers' lawns. The device is similarly simple and effective for operation by homeowners.

According to the preferred embodiment as shown and discussed herein, extension lawnmower system 100 is an innovative modification to the contemporary design of push mowers which enables consumers to mow a larger area of grass and create precision cutting lines, quickly and with relative ease. Extension lawnmower system 100, as shown preferably features specially designed modification(s) to traditional push lawn mowers in that it incorporates foldable extensions on each side of the equipment. In this manner, the extension lawnmower system 100 is able to cover a much wider cutting area. Extension lawnmower system 100 is environmentally-efficient in that a shorter time duration and less fuel may be required to mow the lawn surface being cut. Additionally, cutting decks may be adjacently placed and coupled on one or both sides of primary cutting deck 110. In alternate embodiments more or less auxiliary pivotably attached secondary cutting decks 130 may be included for use and non-use.

Auxiliary pivotably attached secondary cutting decks 130 contain cutting blade(s) 120 and may comprise wheel(s) 128 thus enabling them to work in tandem-cooperation with primary cutting deck 110 during in-use conditions. Hinge-mounted to the side of the primary cutting deck 110, each auxiliary pivotably attached secondary cutting deck 130 preferably measures approximately 21″ in width. Thus, if primary cutting deck 110 is also approximately 21″ (a standard width), then extension lawnmower system 100 in the extended condition, realizes an increased cutting area from about 21″ to about 63″ in width. The extensions may also come with two (2) drop-in covers that allow these “wings” to be folded upwardly, so that extension lawn mower 102 can be used to cut about a 21″ path. Extensions may also be removably couplable wherein extensions may be removed if so desired. A commercial version of the extension lawnmower system 100 may also be available according to another embodiment of the present invention. Used on a commercial lawnmower, the extensions may be able to expand the cutting area from approximately 48″ to 90″ in width. In this way the present invention may provide a cost-effective and efficient lawn cutting means for residential and commercial users. It should also be appreciated that suitable guarding and shrouding may be used to prevent users from contact with moving components.

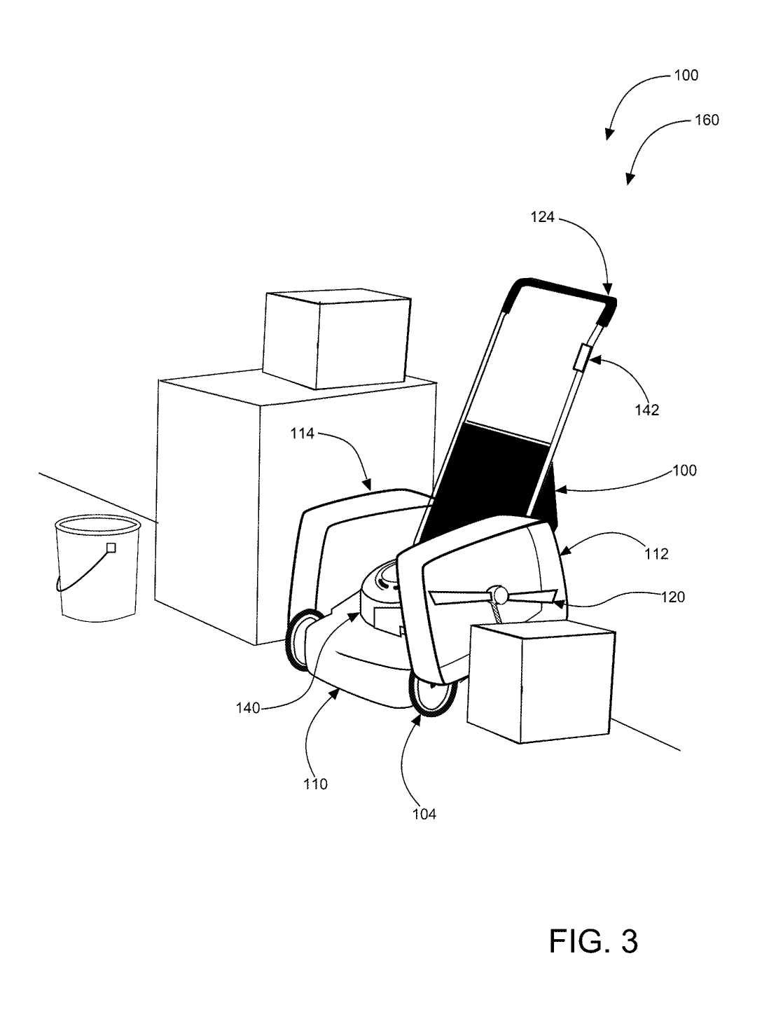

Referring now to FIG. 3, showing a perspective view illustrating extension lawn mower 102 in a non-use storage position 160 according to an embodiment of the present invention of FIG. 1.

Wheeled push extension lawn mower 102 comprising primary cutting deck 110 when in combination with right and left secondary cutting decks 112 allows rotation into an upright non-operating position enabling a non-use condition (non-use storage position 160) which also comprises a storage configuration. As discussed above, extension lawn mower 102 preferably comprises a reduced (folded) width when placed in the storage configuration, requiring a decreased storage footprint. Other embodiments may comprise an extension lawnmower system 100 with a storage configuration of a width of greater than thirty two inches. An advantage of the present design is that the extension lawnmower system 100 when in the storage configuration comprises a width suitable to fit through an entry door. Upon reading this specification, it should be appreciated that, under appropriate circumstances, considering such issues as user preferences, design preference, structural requirements, marketing preferences, cost, available materials, technological advances, etc., other mower deck and side-to-side dimensions such as, for example, larger, smaller, etc., may be sufficient for use with different doors, and/or gate sizes and applications.

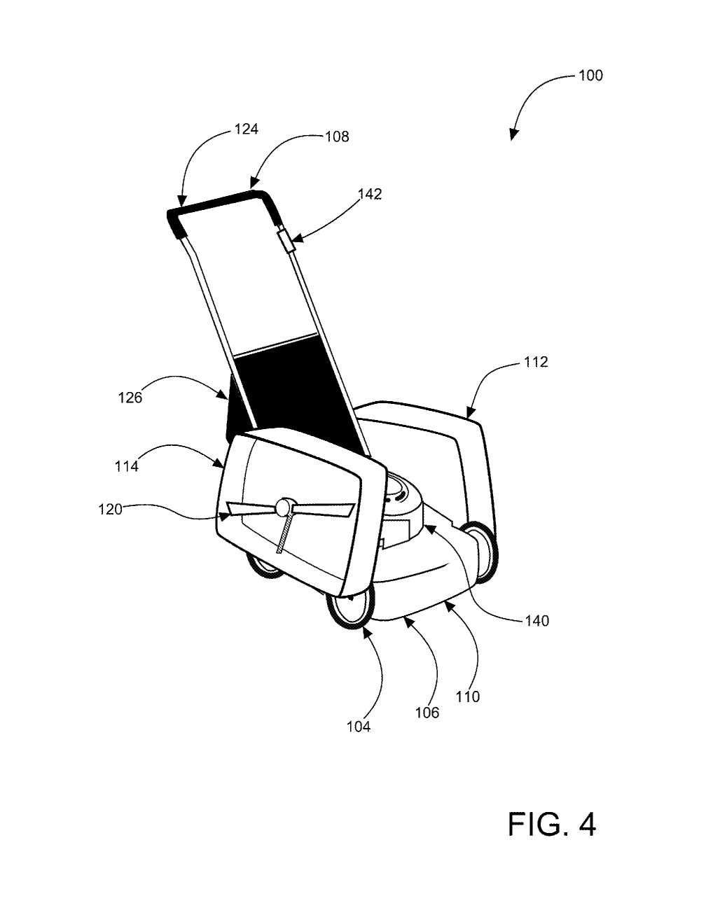

Referring now to FIG. 4 showing a perspective view illustrating right secondary cutting deck 114 and left secondary cutting deck 112 as rotationally-related to wheeled push lawn mower primary cutting deck 110 of extension lawn mower assembly according to an embodiment of the present invention of FIG. 1. Auxiliary pivotably attached secondary cutting deck(s) 130 are vertically rotatable about a centerline axes located preferably on outer side edges of wheeled push lawn mower primary cutting deck 110, as shown. Extension lawn mower assembly may comprise both left and right secondary cutting decks 112 and 114, respectively. Primary cutting deck 110, when in combination with a left and a right secondary cutting deck 112 and 114, respectively, in rotated down positions provide a triple cutting width during an in use condition, as shown in FIG. 1.

Primary cutting deck 110 when in combination with left secondary cutting deck 112 rotated into a down operating position provides a double cutting width during an in use condition as shown in FIG. 2. Extension lawnmower system 100 primary cutting deck 110 when in combination with right secondary cutting deck 114 rotated into a down operating position provides a double cutting width during an in use condition. The extension lawnmower system 100 primary cutting deck 110 when in combination with right and left secondary cutting decks (114, and 112) rotated into an upright non-operating position may provide a single cutting width during an in-use condition.

Extension Lawnmower System 100 may be sold as kit 440 comprising the following parts: one wheeled push lawn mower primary cutting deck 110 with motor 140; at least one auxiliary pivotably attached secondary cutting deck 130 (right and/or left secondary cutting decks (114, and 112); optionally at least one cuttings bag 126 for containing lawn cuttings; at least one (optionally foldable) handle 124; optionally at least one handle-mounted controller 142; and at least one set of user instructions. Extension Lawnmower System 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts for example hinges may be sold separately, etc., may be sufficient.

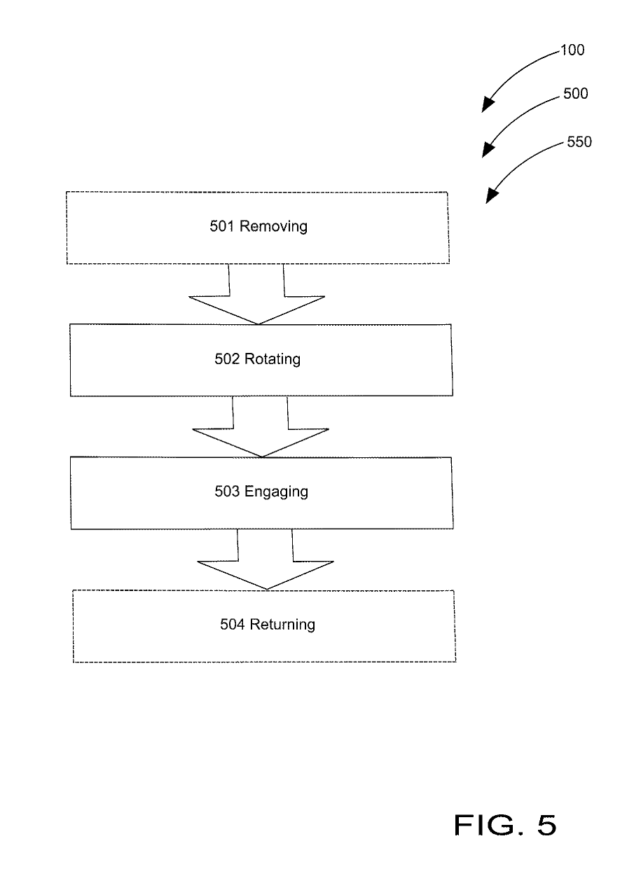

Referring now to FIG. 5, showing a flowchart 550 illustrating a method of use 500 for extension lawn mower assembly of extension lawnmower system 100 according to an embodiment of the present invention of FIGS. 1-4.

A method of use 500 for extension lawnmower system 100 preferably comprises the steps of: step one 501 removing a lawn mower assembly (the lawn mower assembly having a wheeled push lawn mower primary cutting deck 110 hingedly coupled to auxiliary pivotably attached secondary cutting decks 130) from a non-use storage position 160; step two 502 rotating right and/or left secondary cutting decks (114 and 112) downwardly into a horizontal planar relationship with primary cutting deck 110; and step three 503 engaging motor 140 to power at least one cutting blade 120 to perform a lawn cutting operation. The method of use 500 for an extension lawnmower system 100 may further comprise the step four 504 of returning extension lawn mower assembly into non-use storage position 160 during a non-use period. Further, as discussed above this novel mower may be used in different configurations and method of use 500 may be employed, as such with different cutting widths.

It should be noted that steps 501 and 504 are optional steps and may not be implemented in all cases. Optional steps of method 550 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A lawn mower system comprising:
a wheeled push lawn mower primary cutting deck having;
at least one cutting blade;
a connector shaft;
a motor;
a controller; and
at least one auxiliary pivotably attached secondary cutting deck;
wherein said primary cutting deck shrouds said cutting blade(s);
wherein said cutting blade is connected to said motor via said connector shaft;
wherein said motor provides power to operate said cutting blade in a rotary motion;
wherein said motor is variably speed-manipulated by said controller;
wherein said at least one auxiliary pivotably attached secondary cutting deck is hingedly mounted to said wheeled push lawn mower primary cutting deck; and
wherein said wheeled push lawn mower primary cutting deck and said auxiliary pivotably attached secondary cutting decks are usable for cutting at least one outdoor lawn.

2. The lawn mower system of claim 1 wherein said auxiliary pivotably attached secondary cutting decks are vertically rotatable about a centerline axes on side edges located on said wheeled push lawn mower primary cutting deck.

3. The lawn mower system of claim 1 wherein said auxiliary pivotably attached secondary cutting decks comprise a left secondary cutting deck and a right secondary cutting deck.

4. The lawn mower system of claim 3 wherein said wheeled push lawn mower primary cutting deck when in combination with said left and a right secondary cutting decks in a rotated down position provide a triple cutting width during an in-use condition.

5. The lawn mower system of claim 3 wherein said wheeled push lawn mower primary cutting deck when in combination with said left secondary cutting deck rotated into a down operating position provides a double cutting width during an in-use condition.

6. The lawn mower system of claim 3 wherein said wheeled push lawn mower primary cutting deck when in combination with said right secondary cutting deck rotated into a down operating position provides a double cutting width during an in-use condition.

7. The lawn mower system of claim 3 wherein said wheeled push lawn mower primary cutting deck when in combination with said right and left secondary cutting deck rotated into an upright non-operating position provides a single cutting width during an in-use condition.

8. The lawn mower system of claim 3 wherein said wheeled push lawn mower primary cutting deck when in combination with said right and left secondary cutting deck rotated into an upright non-operating position provides a non-use condition.

9. The lawn mower system of claim 8 wherein said non-use condition comprises a storage configuration.

10. The lawn mower system of claim 9 wherein said storage configuration comprises a width of less than thirty two inches.

11. The lawn mower system of claim 9 wherein said storage configuration comprises a width of greater than thirty two inches.

12. The lawn mower system of claim 10 wherein said storage configuration comprises a width suitable to fit through a standard entry door.

13. The lawn mower system of claim 1 wherein said motor comprises an AC motor.

14. The lawn mower system of claim 1 wherein said motor comprises an internal combustion engine.

15. The lawn mower system of claim 3 wherein said left secondary cutting deck and a right secondary cutting deck comprise height-adjustable gauge wheels.

16. The lawn mower system of claim 1 further comprising a cuttings bag.

17. The lawn mower system of claim 1 wherein said controller is handle-mounted.

18. A lawn mower system comprising:
a wheeled push lawn mower primary cutting deck having;
a cutting blade;
a connector shaft;
a motor;
a controller which is handle-mounted;
at least one cuttings bag for containing lawn cuttings; and
at least one auxiliary pivotably attached secondary cutting deck;
wherein said primary cutting deck shrouds said cutting blade;
wherein said auxiliary pivotably attached secondary cutting decks shrouds at least one second cutting blade;
wherein said cutting blade and said second cutting blade(s) are connected to said motor via said connector shaft;
wherein said motor provides power to operate said cutting blade in a horizontal plane rotary motion;
wherein said motor is variably speed-manipulated by said controller;
wherein said at least one auxiliary pivotably attached secondary cutting deck is hingedly mounted to said wheeled push lawn mower primary cutting deck;
wherein said wheeled push lawn mower primary cutting deck and said auxiliary pivotably attached secondary cutting decks are usable for cutting at least one out door lawn;
wherein said auxiliary pivotably attached secondary cutting decks are vertically rotatable about a centerline axes on outside edges located on said wheeled push lawn mower primary cutting deck;
wherein said auxiliary pivotably attached secondary cutting decks comprise a left secondary cutting deck and a right secondary cutting deck;
wherein said wheeled push lawn mower primary cutting deck when in combination with said left and a right secondary cutting decks in a rotated down position provide a triple cutting width during an in-use condition, or wherein said wheeled push lawn mower primary cutting deck when in combination with said left secondary cutting deck rotated into a down operating position provides a double cutting width during an in-use condition, or wherein said wheeled push lawn mower primary cutting deck when in combination with said right secondary cutting deck rotated into a down operating position provides a double cutting width during an in-use condition, or wherein said wheeled push lawn mower primary cutting deck when in combination with said right and left secondary cutting deck(s) rotated into an upright non-operating position provides a single cutting width during an in-use condition;
wherein said wheeled push lawn mower primary cutting deck when in combination with said right and left secondary cutting deck rotated into an upright non-operating position provides a non-use condition;
wherein said non-use condition comprises a storage configuration;
wherein said storage configuration comprises a width of less than thirty six inches;
wherein said storage configuration comprises a width suitable to fit through an entry door;
wherein said motor comprises an internal combustion engine; and
wherein said left secondary cutting deck and a right secondary cutting deck comprise height-adjustable gauge wheels.

19. A method of use for a lawn mower system comprising the steps of:
removing a lawn mower assembly, said lawn mower assembly having a wheeled push lawn mower primary cutting deck hingedly coupled to a right and a left secondary cutting deck, from a storage position;
rotating said right secondary cutting deck and said left secondary cutting deck downwardly into a horizontal planar relationship with said wheeled push lawn mower primary cutting deck; and
engaging a motor to power at least one cutting blade to perform a lawn cutting operation.

20. The method of use for a lawn mower system of claim 19 further comprising the step of returning said lawn mower assembly to said storage position during a non-use period.
